(19) United States
(12) Patent Application Publication
(10) Pub. No.: US 2014/0218159 A1
(43) Pub. Date: Aug. 7, 2014

(54) FUSE

(71) Applicants: Joachim Wosgien, Lohne (DE); Ralf Lange, Horn-Bad Meinberg (DE)

(72) Inventors: Joachim Wosgien, Lohne (DE); Ralf Lange, Horn-Bad Meinberg (DE)

(21) Appl. No.: 14/239,127

(22) PCT Filed: Aug. 17, 2012
(86) PCT No.: PCT/EP2012/066093

§ 371 Date: Mar. 19, 2014

(30) Foreign Application Priority Data
Aug. 18, 2011 (DE) 10 2011 052 805.9

(51) Int. Cl. H01H 85/143; H01H 85/30; H01H 85/36

(52) U.S. Cl. CPC H01H 85/143; H01H 85/36; H01H 85/30
USPC 337/206; 337/186

(57) ABSTRACT

The invention relates to a fuse (3) for connection to a protective component (2) of an overvoltage protective device (2), wherein the fuse (3) has a housing (3f), a first cap (3a), a second cap (3b) and a fuse wire (3d), which runs within the housing between the first cap (3a) and the second cap (3b), wherein the first cap (3a) is designed for thermal and electrical connection to the protective component (2), wherein the fuse wire (3d) is held on the first cap (3a) by means of a soldered connection (3c), wherein the fuse wire (3d) is fastened to a connection electrode (4) opposite the first cap (3a), wherein the connection electrode (4) is held in a guide (8) so as to be movable with respect to the body of the fuse (3) and is under a mechanical pretension (6) with respect to the body of the fuse (3), wherein the fuse wire (3d) is designed such that it melts when acted on with a high I²t, and wherein the soldered connection (3c) is designed such that the soldered connection (3c), in the event of external heating by the overvoltage protective device (2) above a specified temperature, melts due to the thermal connection, and wherein, due to the mechanical pretension (6), the electric contact between the first cap (3a) and the connection electrode (4) is cancelled if the fuse wire (3d) and also the soldered connection (3c) melt.

### CROSS REFERENCE TO RELATED APPLICATION INFORMATION

This application is a U.S. National Stage Application of International Application No. PCT/EP2012/066093 filed Aug. 17, 2012, published as WO2013/024153A1, which claims priority from German Patent Application No. 102011052805.9 filed Aug. 18, 2011, which are incorporated herein by reference in entirety.

### BACKGROUND

The invention relates to a fuse.

Different embodiments of cap fuses with indicators are known from the prior art. Furthermore, fuses are known that are equipped with spring elements and/or resistor elements integrated on account of power dissipation in order to improve the trip behaviour in the vicinity of the tripping current as a result of inherent heating. These fuses however do not provide a thermal fuse that is independent of current.

In order to overcome thermal problems, different circuits were proposed in the past that have a short-circuit fuse with a thermal cutoff as separate components or independent functional units generally connected in series.

Such devices are complex in terms of design and require a large amount of space. In addition, it is difficult with these arrangements to create a cost-effective display capability that simultaneously provides information for both tripping mechanisms.

The object of the invention is to provide a fuse that, in an inventive manner, avoids one or more disadvantages of the solutions known from the prior art.

The object is achieved in accordance with the invention by the features in the independent claims. Advantageous embodiments of the invention are specified in the dependent claims.

### DESCRIPTION OF THE DRAWINGS

The invention will be explained in greater detail hereinafter with reference to the accompanying drawing on the basis of preferred embodiments.

In the drawing

FIG. 1 shows a schematic arrangement of a fuse according to a preferred embodiment of the invention in an overvoltage protective device,

FIG. 2 shows a schematic sectional illustration according to an embodiment of the invention in the untripped state,

FIG. 3 shows a schematic sectional illustration according to an embodiment of the invention in the tripped state as a result of a thermal event,

FIG. 4 shows a schematic sectional illustration according to an embodiment of the invention in the tripped state as a result of an event with high I²t, and

FIG. 5 shows a schematic sectional illustration according to a further embodiment of the invention.

### DETAILED DESCRIPTION OF ILLUSTRATIVE IMPLEMENTATIONS

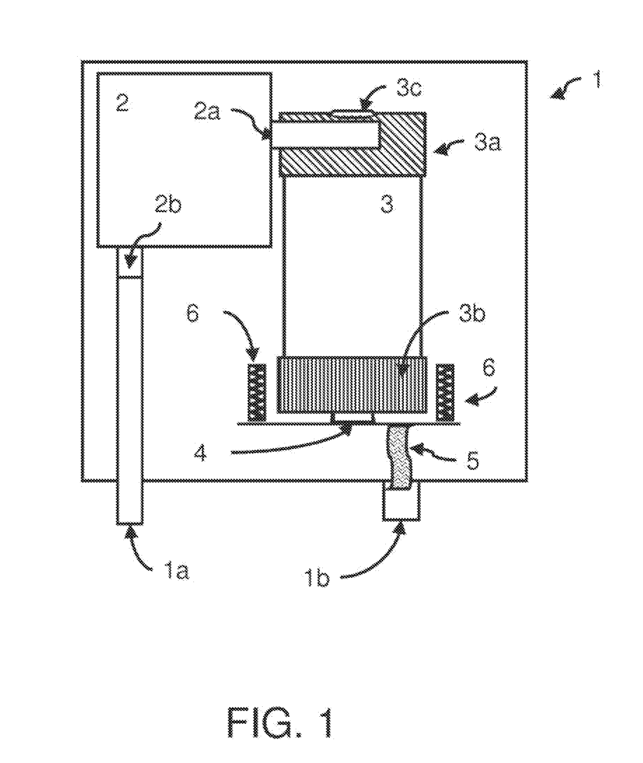

FIG. 1 shows an overvoltage protective device 1 in which a fuse 3 according to the invention can be used. Here, the overvoltage protective device 1 has a protective component 2, for example. The protective component 2 may be a varistor, for example. This protective component 2 has a first connection point 2a and a second connection point 2b. The connection point 2b is electrically connected to the connection point 1a of the overvoltage protective device 1, whereas connection point 2b is electrically and thermally connected to the cap 3a of the fuse 3. The connection electrode 4 is in turn connected by means of a flexible electric connection 5 to the connection point 1b of the overvoltage protective device 1. The fuse 3 has a housing 3f. This can be fabricated from any suitable material, for example from glass or ceramic, and may have a suitable form, for example a cylinder form. Furthermore, the fuse has the aforementioned first cap 3a and a second cap 3b. At least the cap 3a is electrically and thermally conductive in portions. Furthermore, the fuse 3 has at least one fuse wire 3d, which runs within the housing 3f between the first cap 3a and the second cap 3b. During use, the first cap 3a is brought into thermal and electrical connection to the protective component 2. Furthermore, the fuse wire 3d is held on the first cap 3a by means of a soldered connection 3c, and the fuse wire 3d is also fastened to a connection electrode 4 opposite the first cap 3a. The connection electrode 4 is held in a guide 8 in the cap 3b so as to be movable with respect to the body 3f of the fuse 3 and is under a mechanical pretension 6 with respect to the body 3f of the fuse 3. The pretension can be applied, for example, by one or more spring-like elements, without being limited hereto. For example, a repelling magnetic effect could thus alternatively or additionally also provide the corresponding pretension 6.

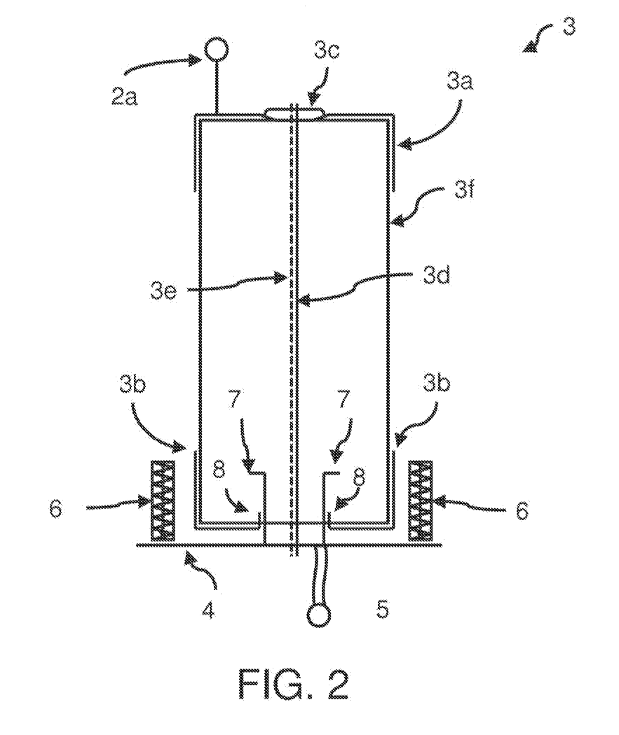

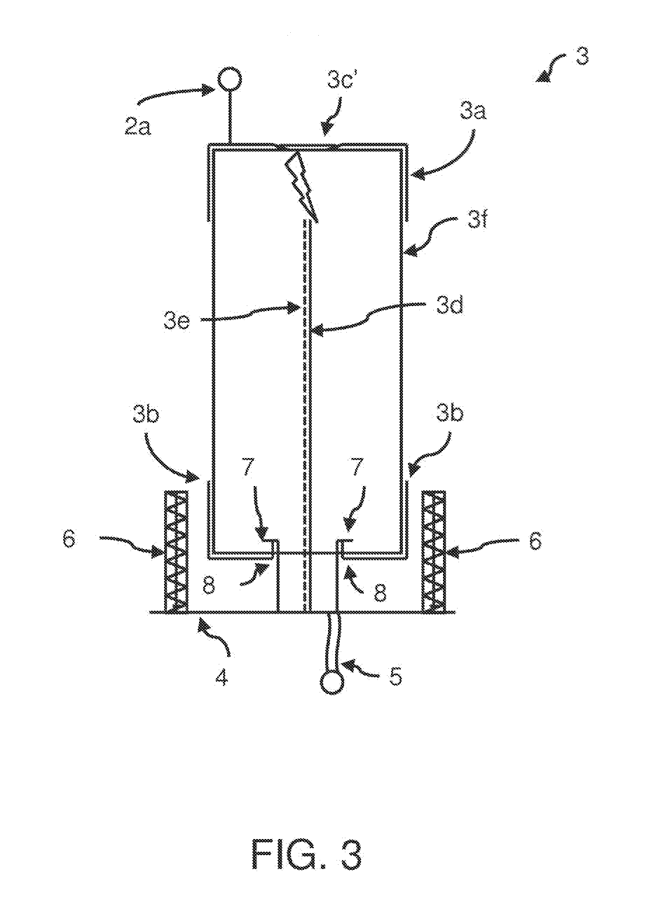

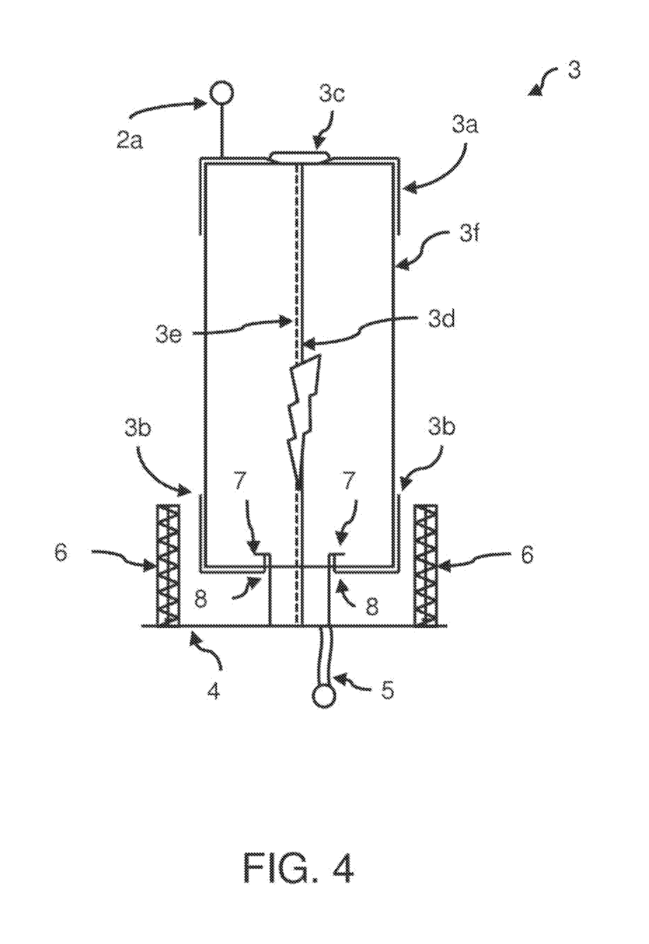

The fuse wire 3d is designed such that it melts when acted on with a high I²t. Such an I²t occurs, for example, if a varistor used as a protective component 2 is broken down. Then, a high current flows over a relatively short period of time. In order to prevent this current flow, this large current input is to lead to a melting of the fuse element 3d within a relatively short period of time, for example within fractions of seconds. Typical currents that flow in this case lie in the region of 10 amps, 100 amps and more. Such a situation is illustrated in FIG. 4. On the other hand, the fuse wire is also dimensioned such that any pulse current to be carried, for example in the event of a transient event, can be easily carried and removed. Furthermore, the soldered connection 3c is designed such that the soldered connection 3c, in the event of external heating by the protective component 2 above a specified temperature, melts due to the thermal connection via the connection point 2a to the cap 3a. Thermal fuse protection of this type is rather slow compared to the melting of the fuse wire and takes between seconds and minutes or more. The core concept is that a slow thermal death of a protective component 2 also leads to tripping of the fuse 3. However, the fuse element 3d then will not melt, but instead the soldering point 3c. This situation is illustrated in FIG. 3, where the solder of the soldered connection is softened and is denoted by 3c′ in contrast to FIG. 2. A typical solder that can be used for the soldered connection 3c is a suitable low-temperature solder, for example having a soldering temperature of 143° C. or tin solder tubes made of Bi/Pb/Cd or the like. Of course, it is also possible to design the fuse wire 3d itself as a soldering point 3c.

If the soldering point 3c softens or the fuse wire 3d melts, the electric contact existing beforehand from the cap 3a via the fuse wire 3d to the connection electrode 4 is cancelled due to the mechanical pretension 6.

The aforementioned design makes it possible to combine two functions in a single fuse, specifically a thermal fuse and a short-circuit fuse. Due to the property that both functions are combined in a single fuse, the design is small and can additionally be produced cost-effectively.

In an advantageous development of the invention the fuse wire 3d, as shown in FIGS. 3 and 4, is moved away from the soldered connection 3c into the housing 3f as a result of the mechanical pretension 6. It can thus be ensured that a formed arc, which is indicated as a lightning symbol in FIGS. 3 and 4, does not occur outside the fuse, thus ensuring reliability of the fire protection offered.

Furthermore, the housing 3f may have a filling, at least in portions, comprising an arc-extinguishing material, such as sand or POM.

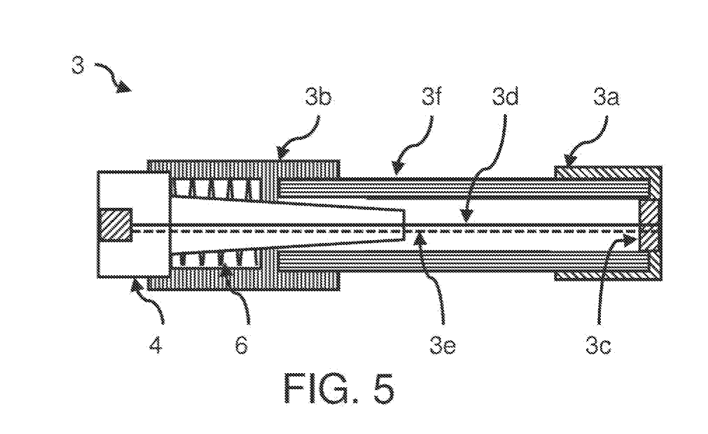

In a further advantageous development of the invention the mechanical pretension 6 is a spring force, wherein the spring(s) is/are arranged either in the housing (as shown in FIG. 5), in particular between the cap 3b and connection electrode 4, or (as shown in FIGS. 2, 3 and 4) outside the housing. An arrangement inside protects against contaminations, but has the advantage that the state of the spring cannot be controlled without further measures.

In yet a further advantageous development of the invention a retaining wire 3e is guided parallel to the fuse wire 3d. This retaining wire 3e is highly resistive, in contrast to the fuse wire 3d, and is intended to prevent the mechanical pretension 6 from releasing the fuse wire 3d prematurely. Due to the highly resistive embodiment with simultaneously greater strength than the fuse wire 3d, the current will flow substantially via the fuse wire 3d. If this current is too high over a short period of time (high I²t), the fuse wire 3d will melt and current will then flow through the retaining wire 3e. Due to the higher resistance, it will also melt practically immediately. The fuse wire 3d will therefore generally have a high Cu or Al proportion, whereas the retaining wire 3e can be fabricated from constantan, for example.

In yet a further advantageous development of the invention the retaining wire 3e is electrically and mechanically connected to the connection electrode 4, wherein the fuse wire 3d and the retaining wire 3e are connected to the electric connection cap 3a, arranged opposite, via the soldered connection 3c.

In yet a further advantageous development of the invention the fuse 3 further has a display means in order to display the tripping of the fuse. This display may be a mechanical display for example, which is moved with the movable connection electrode 4 and for example provides a colour change from green to red, and/or a switch, for example a microswitch, may be provided which is actuated by the movable connection electrode 4 and closes or opens a corresponding circuit and/or triggers a remote warning.

In yet a further advantageous development of the invention the display means displays the tripping of the fuse 3 if the soldered connection 3c melts and also similarly if the fuse element 3d melts. Independently of the damaging event, the need to replace the fuse 3 and the associated protective component 2 or, if the fuse 3 is arranged in an overvoltage protective device 1, the overvoltage protective device 1, is thus displayed. The component complexity is thus further reduced and a small overall size is made possible.

In yet a further advantageous development of the invention the movable connection electrode 4 is simultaneously the display means.

In yet a further advantageous development of the invention the movable connection electrode 4 has contact means 7, which are shown in FIGS. 2, 3 and 4, are arranged inside the housing 3f and contact the guide 8 inside the housing 3f in the event that the fuse 3 is tripped.

In yet a further advantageous development of the invention the movable connection electrode 4 has an extension directed inwardly into the housing 3f, wherein the housing 3f has a filling, at least in portions, comprising an arc-extinguishing material.

It is thus ensured that any arc formed cannot pass outside.

The objective of the invention is therefore to integrate in the overvoltage protective device 1, besides the thermal fuse (separation device), an additional overcurrent protection means that is adapted to the requirements and to the short-circuit strength of the construction. The objective is achieved by a combination of these two completely different requirements (the thermal separation and the overcurrent separation) in a single component. Such a fuse with “dual function” provides much better protection in various fault situations, on the one hand in the case of small fault currents, which are accompanied by a temperature rise of the protective component (for example: MOV=metal-oxide varistor), and tripping is enabled in the event that a temperature is exceeded, on the other hand in the event of medium and high currents, which may occur if the protective component is overloaded suddenly, thus assuming a low-resistance state. The varistor 2 is in this case usually “broken down” and has reduced power dissipation and therefore generates less heat. Here, the fault current may still adopt very high values however that may correspond to the short-circuit current of the voltage source. Such a fuse therefore requires a switch-off capacity until in the kA range. The “dual function” in a fuse element reduces costs and individual parts, assembly effort, and is suitable for use in order to protect overvoltage protective components 1 in order to meet safety requirements and the requirements as specified in the relevant standards. For suitability in an overvoltage protective device, the transient pulse strength of the selected fuse members has to be particularly high or has to be adapted to the impulse current strength. This generally constitutes a compromise between a necessary minimum strength (that is to say no tripping in the region of the specified pulse current strength of the overvoltage protective device) and reliable and rapid tripping for short-circuit protection or in the event of failure of one of the internal components.

List of reference signs
Key:

| | |
|---|---|
| overvoltage protective device | 1 |
| electric connection points | 1a, 1b |
| protective component | 2 |
| elec. connection points of the protective component | 2a, 2b |
| fuse | 3 |
| cap | 3a, 3b |
| soldered connection | 3c |
| fuse wire | 3d |
| retaining wire | 3e |
| housing | 3f |
| movable connection electrode | 4 |
| flexible electric connection | 5 |
| pretension | 6 |
| contact means | 7 |
| guide | 8 |

1. A fuse for connection to a protective component of an overvoltage protective device (2), the fuse comprising:
a housing (3f), a first cap, a second cap and a fuse wire, which runs within the housing between the first cap and the second cap,
wherein the first cap is designed for thermal and electrical connection to the protective component,
wherein the fuse wire is held on the first cap via a soldered connection,
wherein the fuse wire is fastened to a connection electrode opposite the first cap,
wherein the connection electrode is held in a guide so as to be movable with respect to the body of the fuse and is under a mechanical pretension with respect to the body of the fuse,
wherein the fuse wire is designed such that it melts when acted on with a high I²t,
wherein the soldered connection is designed such that the soldered connection, in the event of external heating by the overvoltage protective device above a specified temperature, melts due to the thermal connection, and
wherein, due to the mechanical pretension, the electric contact between the first cap and the connection electrode is cancelled if the fuse wire and also the soldered connection melt.

2. The fuse according to claim 1, characterized in that cancellation of the electric contact is caused by moving the fuse wire away from the soldered connection and into the housing as a result of the mechanical pretension.

3. The fuse according to claim 1, characterized in that the mechanical pretension is a spring force, wherein the spring is arranged either in the housing, or externally on the housing.

4. The fuse according to claim 1, characterized in that the housing has a filling, at least in portions, comprising an arc-extinguishing material.

5. The fuse according to claim 1, further comprising a retaining wire guided parallel to the fuse wire.

6. The fuse according to claim 5, characterized in that the retaining wire is electrically and mechanically connected to the connection electrode, wherein the fuse wire and the retaining wire are connected to the electric connection cap, arranged opposite, via the soldered connection.

7. The fuse according to claim 1, further comprising display means for displaying the tripping of the fuse.

8. The fuse according to claim 7, characterized in that the display means displays the tripping of the fuse if the soldered connection melts and also similarly if the fuse element melts.

9. The fuse according to claim 7, characterized in that the movable connection electrode is simultaneously the display means.

10. The fuse according to claim 1, characterized in that the movable connection electrode has contact means, which are arranged inside the housing and bear against the guide inside the housing if the fuse is tripped.

11. The fuse according to claim 10, characterized in that the movable connection electrode has an extension guided inwardly into the housing, wherein the housing has a filling, at least in portions, comprising an arc-extinguishing material.

12. The fuse according to claim 2, characterized in that the mechanical pretension is a spring force, wherein the spring is arranged either in the housing, in between the cap and the connection electrode, or externally on the housing.

13. The fuse according to claim 2, characterized in that the housing has a filling, at least in portions, comprising an arc-extinguishing material.

14. The fuse according to claim 2, further comprising a retaining wire guided parallel to the fuse wire.

15. The fuse according to claim 14, characterized in that the retaining wire is electrically and mechanically connected to the connection electrode, wherein the fuse wire and the retaining wire are connected to the electric connection cap, arranged opposite, via the soldered connection.

16. The fuse according to claim 2, further comprising display means for displaying the tripping of the fuse.

17. The fuse according to claim 16, characterized in that the display means displays the tripping of the fuse if the soldered connection melts and also similarly if the fuse element melts.

18. The fuse according to claim 8, characterized in that the movable connection electrode is simultaneously the display means.

19. The fuse according to claim 2, characterized in that the movable connection electrode has contact means, which are arranged inside the housing and bear against the guide inside the housing if the fuse is tripped.

20. The fuse according to claim 19, characterized in that the movable connection electrode has an extension guided inwardly into the housing, wherein the housing has a filling, at least in portions, comprising an arc-extinguishing material.
